(19) United States
(12) Patent Application Publication
(10) Pub. No.: US 2016/0306531 A1
(43) Pub. Date: Oct. 20, 2016

(54) Dynamic Launch Behavior Based on Context Information

(71) Applicant: Microsoft Technology Licensing, LLC, Redmond, WA (US)

(72) Inventors: Tsz Yan Wong, Seattle, WA (US); Richard Fang, Bellevue, WA (US); Michael A. Seibert, Redmond, WA (US); Christopher Doan, Seattle, WA (US); Christopher E. Swan, Bellevue (WA); Christopher R. Anthony, Bellevue, WA (US); Yaou Wei, Redmond, WA (US); Adam E. Barrus, Bellevue, WA (US); Chaitanya Dev Sareen, Seattle, WA (US)

(21) Appl. No.: 14/689,046

(22) Filed: Apr. 16, 2015

(51) Int. Cl. G06F 3/0484; G06F 3/0481

(52) U.S. Cl. CPC G06F 3/04847; G06F 3/0481

(57) ABSTRACT

Window-invoking functionality is described herein for leveraging context information to present a graphical control element (e.g., a window) of an application in a manner that most likely corresponds to the underlying intent of a user. By doing so, the window-invoking functionality improves the efficiency of the user in interacting with the application, and also reduces consumption of computing resources. In one implementation, the window-invoking functionality includes an information gathering component for collecting the context information, and an invocation component for selecting a particular virtual desktop on which to present the graphical control element, based on the context information.

### BACKGROUND

A virtual desktop manager allows a user to create and interact with different virtual desktops on a single computing device. The different virtual desktops provide different respective graphical portals through which a user may interact with applications, files, etc. For example, a user may create a first virtual desktop to interact with various personal application windows, and a second virtual desktop to interact with various work-related application windows. The user may toggle between these two desktops throughout the day, depending on whether he or she wishes to perform personal tasks or work-related tasks. In current implementations, however, applications may interact with the virtual desktop manager to sometimes invoke application windows in virtual desktops in a way that the user neither expected nor desired.

### SUMMARY

Window-invoking functionality is described herein for leveraging context information to present a graphical control element (e.g., a window) of an application in a manner that most likely corresponds to the underlying intent of a user. By doing so, the window-invoking functionality improves the efficiency of the user in interacting with the application, and also reduces consumption of computing resources. In one implementation, the window-invoking functionality includes an information gathering component for collecting the context information, and an invocation component for selecting a particular virtual desktop on which to present the graphical control element, based on the context information.

In one scenario, for instance, assume that the user makes a request to launch an application. The information gathering component can determine that the user is interacting with a current virtual desktop that does not contain a graphical control element associated with the application. In response, the invocation component can present the graphical control element on the current virtual desktop, even in the circumstance in which another existent virtual desktop already contains a graphical control element associated with the application. In other words, in this example, the window-invoking functionality does not send the user to the other virtual desktop or invoke an application event in the other virtual desktop without knowledge of the user, but rather assumes that the user wants to remain in the current virtual desktop. The window-invoking functionality eliminates the need for the user to navigate from an undesirable presentation to the desired presentation, and eliminates the expenditure of computing resources that would be needed to present the undesirable presentation.

The information gathering component can use different techniques to collect the context information. In one approach, the information gathering component can rely on an application to collect the context information, once the application is activated. In another approach, the information gathering component can collect at least some of the context information (such as preloaded preference information) prior to activating the application, thereby further conserving computing resources.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a system for presenting graphical control elements (e.g., windows) within virtual desktops based on context information.

FIG. 2 shows an example of illustrative behavior of the system of FIG. 1.

FIG. 3 shows computing functionality for implementing the system of FIG. 1.

FIG. 4 shows a standalone implementation of the computing functionality of FIG. 3.

FIG. 5 shows a network implementation of the computing functionality of FIG. 3.

FIG. 6 shows a first particular implementation of the system of FIG. 1.

FIG. 7 shows a second particular implementation of the system of FIG. 1.

FIG. 8 shows an example of illustrative behavior of the second implementation of FIG. 7.

FIG. 9 shows a third particular implementation of the system of FIG. 1.

FIG. 10 is a flowchart that describes one manner of operation of the system of FIG. 1.

FIG. 11 shows illustrative computing functionality that can be used to implement any aspect of the features shown in the foregoing drawings.

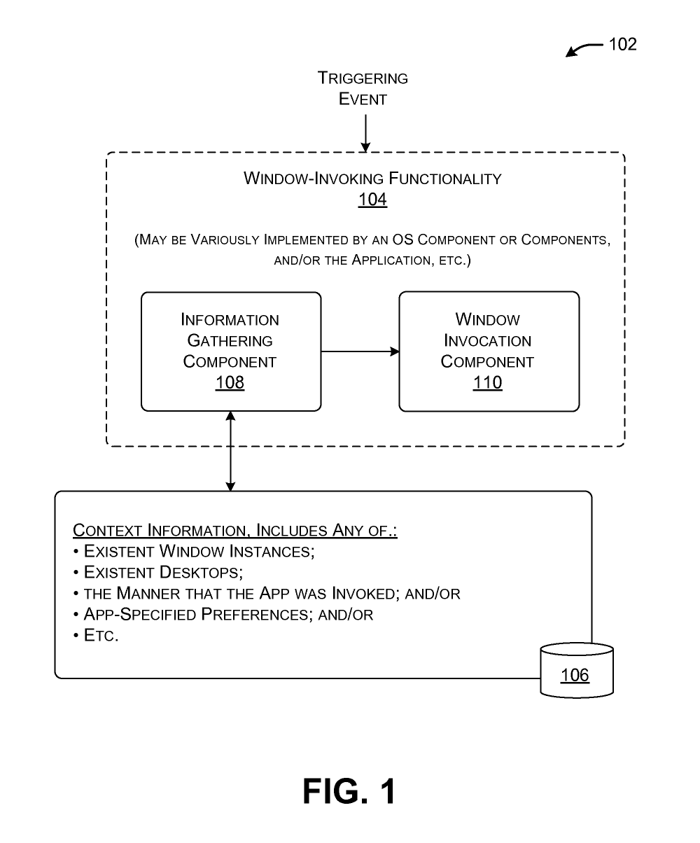

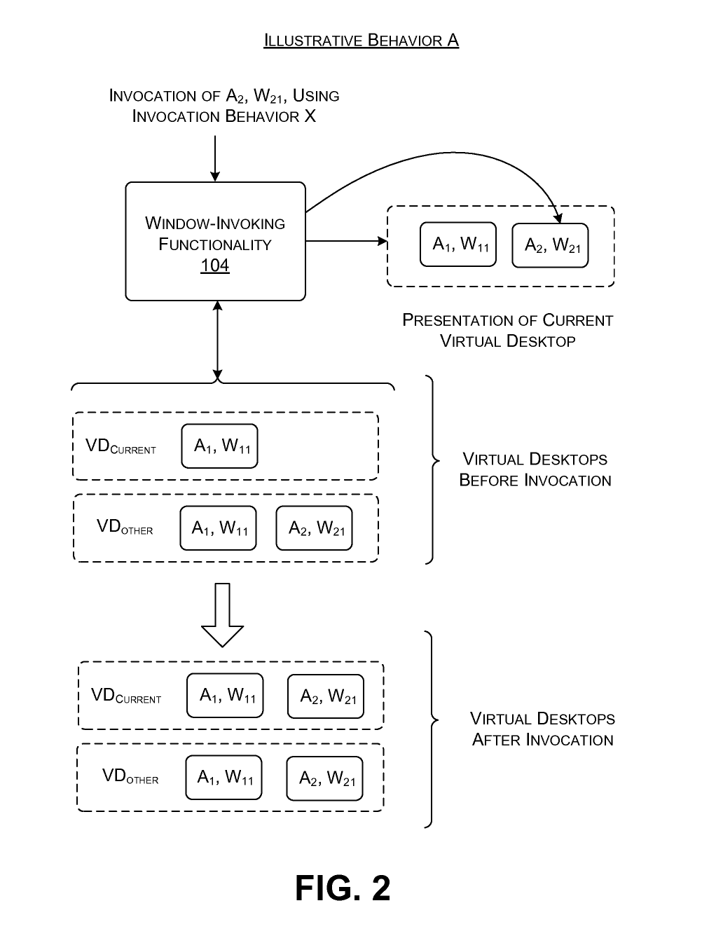

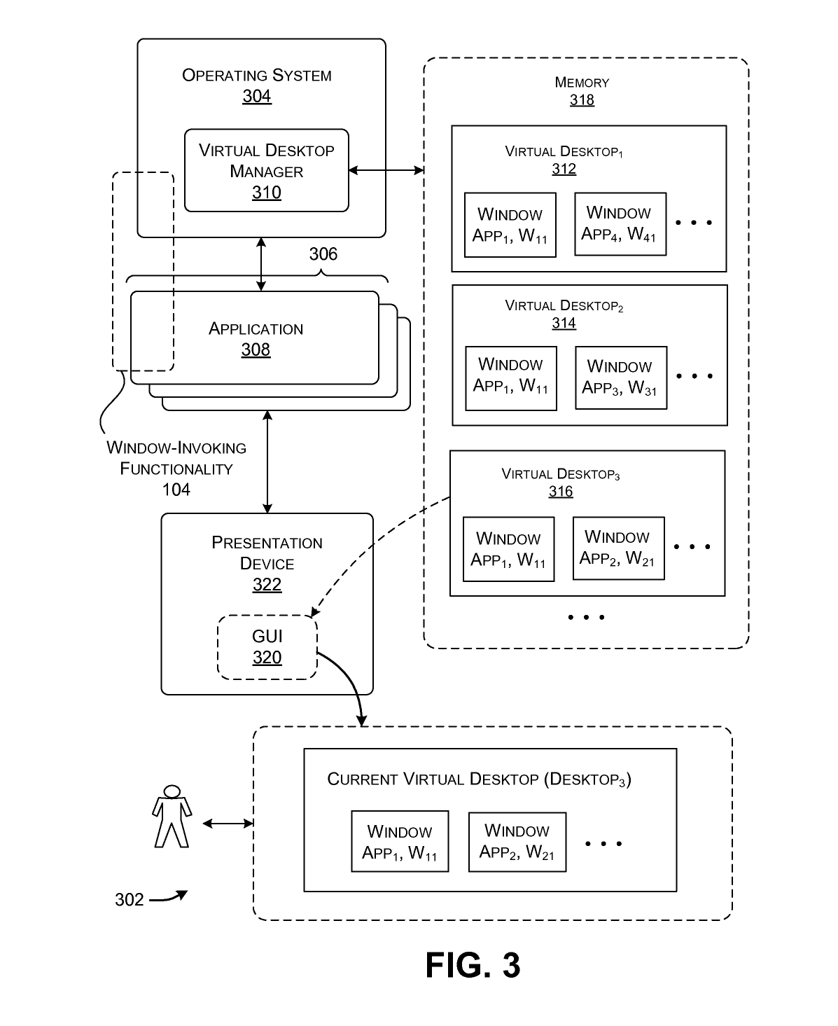

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a system for presenting graphical control elements (e.g., windows) within virtual desktops based on context information. Section B sets forth an illustrative method which explains the operation of the system of Section A. Section C describes illustrative computing functionality that can be used to implement any aspect of the features described in Sections A and B.

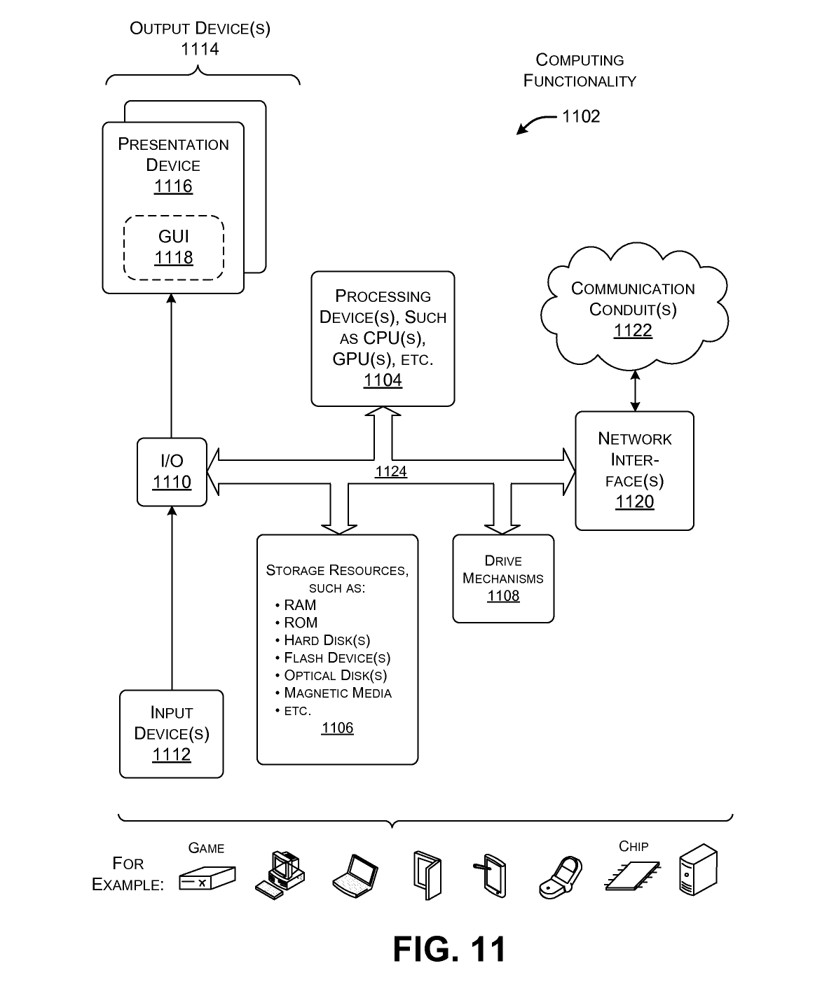

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 11, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

FIG. 1 shows an overview of a system 102 for presenting graphical control elements within virtual desktops based on context information. To facilitate explanation, the graphical control elements will henceforth be referred to with respect to the specific example of windows. The windows correspond to graphical panels that allow end users to interact with applications to which they pertain, via a graphical user interface (GUI). But more generally, the graphical control elements may correspond to any graphical features by which users may interact with respective applications. For example, in one instance, the graphical control elements may correspond to popup messages (not necessarily in window form) that are presented by a particular application.

The term “application” as used herein is intended to broadly correspond to any computer-implemented functionality which performs any function. In some cases, the application may correspond to a program (and/or other manifestation of logic) that executes relatively high-level functions. But in other cases, the application may correspond to a program (and/or other manifestation of logic) that executes lower-level functions, such as operating system functions. Also note that the term “application” is to be considered synonymous with application functionality or application logic, in that it refers to the functionality that is produced when application code (and/or other logic) is executed by at least one computing device, as opposed to the to the application code per se.

The system 102 includes window-invoking functionality 104 which interacts with a computing device's operating system (including its virtual desktop manager) to present a requested window on an appropriate virtual desktop (such as the current virtual desktop with which the user is currently interacting). The requested window is associated with a particular application and allows the user to interact with that application. The window-invoking functionality 104 performs its operation on the basis of context information, provided in one or more data stores 106. As generally used herein, a data store refers to any mechanism for retaining information, such as dynamic memory, persistent storage (e.g., hard disc), etc.

More specifically, the window-invoking functionality 104 operates by receiving a triggering event that initiates the presentation of the requested window. In one case, for example, the triggering event may correspond to an instruction by a user to activate (e.g., “launch”) the particular application. That is, the triggering event in this case corresponds to an instruction by the user to present a requested window associated with the application, which thereafter allows the user to interact with the application. For instance, the triggering event may correspond to a request by the user to activate a browser application (e.g., INTERNET EXPLORER produced by Microsoft Corporation® of Redmond, Wash.), which invokes a window that initially displays the user's homepage or some other page.

The user can invoke the application in different ways. In one case, the user may activate the application by clicking on (or otherwise selecting) an icon (or other information) associated with the application in a start menu, a task bar, etc. In another case, the user may activate the application by clicking on a file item that is associated with the application. For instance, the user may activate a word processing application by clicking on a document that was created by the word processing application, or otherwise has a file extension associated with the word processing application. In another case, the user may activate the application by launching it via a specified protocol. For instance, the user may activate a browser application by activating an http link to a particular web page. These user-implemented invocation strategies are cited by way of example, not limitation; still further techniques may be available to a user for activating the application.

In yet other cases, the triggering event may correspond to a request by an already-running application to present a window associated with that application, or some other application. In other words, that triggering event is generated by the application, not the user. For example, assume that the application corresponds to a computer-implemented calendar service, and that this application is already running. At some juncture, the application may generate a request to the window-invoking functionality 104 to present a reminder window, which serves to remind the user of an upcoming meeting.

The window-invoking functionality 104 can include (or can be conceptualized as including) two main components. An information gathering component 108 collects the relevant pieces of context information. The following description sets forth various techniques by which the information gathering component 108 may perform this task. An invocation component 110 uses the collected context information to determine an appropriate manner in which to present the requested window, referred to herein as the preferred identified manner. The invocation component 110 then interacts with the operating system (of the computing device on which the application runs) to present the requested window in the preferred identified manner.

More specifically, the virtual desktop manager may be hosting plural virtual desktops, each of which may be presenting one or more windows associated with one or more applications. Further assume that the user is interacting with a current virtual desktop. In one case, the invocation component 110 selects a virtual desktop that is deemed to be most appropriate to present the requested window, based on the context information. The chosen virtual desktop may correspond to the current virtual desktop with which the user is currently interacting; but in other cases, the invocation component 110 may choose another virtual desktop in which to present the requested window. In other words, the “preferred identified manner” in this example specifies the identity of the virtual desktop that is to be used to present the requested window.

Alternatively, or in addition, the “preferred identified manner” specifies a display characteristic of the requested window, pertaining to some visual and/or behavioral aspect of the requested window when presented on a desktop. For instance, assume that the application performs a calculation function. The invocation component 110 can leverage the context information to present a small-sized version of this window in certain circumstances. The above-described behavior of the window-invoking functionality 104 also has applicability to the situation in which the user interacts with a single virtual desktop or just an ordinary desktop.

Alternatively, or in addition, the “preferred identified manner” refers to a display characteristic that describes a feature of one or more presentation devices on which the graphical control element is presented. For instance, the context information may specify a particular presentation device (or devices) among a plurality of presentation devices on which the graphical control element could be presented. The invocation component 110 leverages the context information to present the graphical control element on the chosen presentation device(s), and/or to govern the presentation settings on the chosen presentation device(s).

However, to facilitate and simplify explanation, the remaining explanation will mainly focus on the example in which the “preferred identified manner” involves presenting the requested window on a particular virtual desktop.

The context information may include information regarding all windows associated with the application that exist at the current time, as presented in one or more virtual desktops. That information may be maintained by the application itself and/or the computing device's operating system. The context information may also include information regarding all of the virtual desktops that exist at the current time, and the windows associated therewith. That information may be maintained by the virtual desktop manager provided by the computing system's operating system, and/or some other component of the operating system.

The context information may also include invocation characteristic information, specifying a manner by which the triggering event has been produced. For example, the invocation characteristic information may indicate whether a user has launched an application (such as a browser application) by: clicking on an http link or by invoking some other protocol; or by clicking on an icon (or other control element) in a task bar, start menu, desktop presentation, etc.; or by activating a particular file item or the like (such as a document, image, etc.); or by performing particular invocation behavior (such as by executing a particular user interface gesture); etc., or some combination thereof. The invocation characteristic information may be provided by the computing device's operating system when the user launches an application. In other cases, the invocation characteristic information may indicate the circumstance in which an already-running application automatically invokes a window.

The context information may also include preference information specified by the particular application. The application preference information identifies a preferred manner of invoking the requested graphical control element for the particular application. The preference information may be maintained by the computing device's operating system. The computing device's operating system, in turn, may receive the preference information from the application at a given time (e.g., install time, runtime, etc.).

The preference information may be expressed as one or more rules that describe how the window-invoking functionality 104 is to display the requested window, for various invoking conditions. For example, one instance of preference information may specify that a requested window is to be displayed on the current desktop when the user invokes the application in a certain way, but not other ways. Such a rule can be expressed in any manner, such as IF-THEN logic, or one or more attributes that are acted on by appropriate logic of the window-invoking functionality 104, etc.

Different systems may implement the window-invoking functionality 104 in different respective ways. In some cases, at least some aspects of the window-invoking functionality are implemented by logic within the particular application itself. In addition, or alternatively, at least some aspects of the window-invoking functionality 104 are implemented by one or more operating system components. The explanation below will provide three illustrative implementations of the window-invoking functionality 104.

Overall, the window-invoking functionality 104 leverages the context information by displaying the requested window in the manner that the user most likely intended. For example, the window-invoking functionality 104 displays the requested window in a particular virtual desktop in which the user most likely intended for the requested window to be displayed. This behavior allows a user to efficiently interact with the virtual desktops. The behavior also may result in the efficient consumption of the computing resources (e.g., battery power) of the computing device(s) which implement the application.

To illustrate the above assertions, consider the example of FIG. 2. Here, at a current time, a request is made to invoke a window W₂₁ associated with an application A₂. For example, assume that the user clicks on an icon associated with application A₂ in a taskbar or start menu. Further assume that, upon invocation, the application A₂ will present the window W₂₁.

Further assume that, at the current time, the virtual desktop manager is hosting two existent virtual desktop, VD_{Current} and VD_{Other}. VD_{Current} corresponds to the virtual desktop with which the user is currently interacting. It includes just window W₁₁ associated with an application A₁. VD_{Other} corresponds to another virtual desktop with which the user is not currently interacting, but is nevertheless existent in the sense that it exists in memory and the user may readily switch to it. VD_{Other} includes window W₁₁ associated with application A₁, as well as window W₂₁ associated with application A₂. Generally note that a virtual desktop can present any number of windows associated with any number of applications.

The window-invoking functionality 104 operates by collecting context information which describes at least the windows that exist for application A₂, as well as the virtual desktops in which these windows appear. In response to this context information, the window-invoking functionality 104 then decides to present the requested window (i.e., window W₂₁ associated with application A₂) in the current virtual desktop (VD_{Current}). The window-invoking functionality 104 chooses this behavior even though the inactive virtual desktop (VD_{Other}) happens to be also be displaying window W₂₁ of application A₂. In other words, the window-invoking functionality 104 declines to switch the user to VD_{Other} and then activate the existing window (W₂₁, A₂) in that virtual desktop.

The above-described behavior of the window-invoking functionality 104 behavior is predicated on the assumption that the user most likely desired to invoke a new instance of window W₂₁ of application A₂, rather than activate the already-existing instance of window W₂₁ of application A₂ in VD_{Other}. However, this assumption is merely one example. Based on other contextual cues, another implementation of the window-invoking functionality 104 may decide that the most appropriate action would be to reactive the existing instance of the window W₂₁ of application A₂ in VD_{Other}.

The window-invoking functionality 104 allows the user to efficiently interact with the virtual desktops. To illustrate this point, consider what might have happened had the window-invoking functionality 104 decided to activate the already-existing instance of window W₂₁ of application A₂ within VD_{Other}. The window-invoking functionality 104 could have performed this task by pulling the user out of VD_{Current}, and placing the user into VD_{Other}. Or the window-invoking functionality 104 may have activated the window W₂₁ in application A₂ without also placing the user in VD_{Other}. In either case, the user may not immediately understand what is happening, leading to confusion and frustration. And once the user does determine what has happened, the user may need to perform additional steps to achieve the interface state that is being sought—namely, the presentation of window W₂₁ of application A₂ in VD_{Current}, not VD_{Other}. The window-invoking functionality 104 can be said to promote efficient interaction by eliminating the confusion, frustration, and additional operations that may be incurred by pushing the user into VD_{Other}, when that is not the user's underlying intent.

Further, the window-invoking functionality 104 may result in the efficient utilization of computing resources. In one implementation, the computing device which hosts the virtual desktop manager may suspend the application in any non-current virtual desktop. In the context of the example of FIG. 2, this means that the computing device may suspend the presentation of window W₁₁ of application A₁ and window W₂₁ of application A₂ in the context of VD_{Other}. The computing device will reactive these instances, however, when the virtual desktop manager switches to VD_{Other}. The computing device consumes additional power in the process of presenting active instances of windows, as opposed to suspended instances of windows. Hence, by incorrectly “throwing” the user into an unintended virtual desktop, the computing device can be said to needlessly consume its power. And by reducing these types of errant activations, the window-invoking functionality can be said to conserve the power of the computing device over a span of time. Such a characteristic may confer heightened benefit in those cases in which the computing device is a handheld battery-driven device having finite, relatively limited, battery capacity.

Although not shown in FIG. 2, alternatively assume that the user requests the window-invoking functionality 104 to invoke window W₁₁ of application A₁ (instead of application A₂). In this example, both VD_{Current} and VD_{Other} display an instance of window W₁₁ of application A₁. In response to this finding, the window-invoking functionality 104 may decide to invoke the existing instance of window W₁₁ of application A₁ within VD_{Current}, without invoking a duplicate window in the same virtual desktop. But this also is not a fixed rule; in other cases, for other contextual cues, the window-invoking functionality 104 may decide to invoke two windows of the same application in the same virtual desktop, such as by invoking two browser windows.

As noted above, in other implementations (also not shown in FIG. 2), the window-invoking functionality 104 may determine how to present a requested window based on two or more contextual factors (instead of just a determination of whether the requested widow appears in VD_{Current}). For example, the window-invoking functionality 104 may resort to a first invoking strategy if the user makes the application request in a first manner, and resort to a second invoking strategy if the user makes the application request in a second manner.

In addition, or alternatively, the window-invoking functionality 104 can use contextual cues to determine the manner in which a requested window is to be displayed in a virtual desktop, that is, in addition to determining the particular virtual desktop in which the virtual desktop is to be displayed. For example, in addition to determining that the window W₂₁ of application A₂ is to be presented in VD_{Current}, the window-invoking functionality 104 can determine any of: the size (and/or any other visual attribute) of the window within the chosen virtual desktop, the position of the window within the virtual desktop, the behavior of the window within the chosen virtual desktop, the presentation device(s) on which the window is displayed, etc. All such attributes are referred to herein as display characteristics. Indeed, the window-invoking functionality 104 can present a window based on contextual cues even if the virtual desktop manager is currently hosting only one virtual desktop (and hence there is only once choice of virtual desktop on which to display the requested window), or the operating system is presenting an “ordinary” (non-virtual) desktop.

FIG. 3 shows computing functionality 302 for implementing the system of FIG. 1. A computing device (not shown) hosts an operating system 304 and one or more applications 306. One such application may correspond to a particular application 308, such as a browser application, which invokes the window-invoking functionality 104. The operating system 304, in turn, implements a virtual desktop manager 310. In the example of FIG. 3, the virtual desktop manager 310 is currently hosting at least three virtual desktops (312, 314, 316) within the computing device's memory 318. The current virtual desktop, with which the user is currently interacting, is virtual desktop₃ 316.

As noted above, different components of the computing device (or devices) may implement the windowing-invoking functionality 104. For example, one or more components of the operating system 304 may implement at least part of the window-invoking functionality 104. In addition, or alternatively, logic within one or more applications 306 may implement at least part of the window-invoking functionality 104. To repeat, the following description will provide concrete examples of different illustrative ways of implementing the window-invoking functionality 104.

The computing device displays at least the current virtual desktop 316 in a graphical user interface (GUI) 320 of a presentation device 322 (or devices). For example, the presentation device 322 may correspond to a computer display of any size and type (such as liquid crystal display). The user interacts with the computing device via the graphical user interface 320.

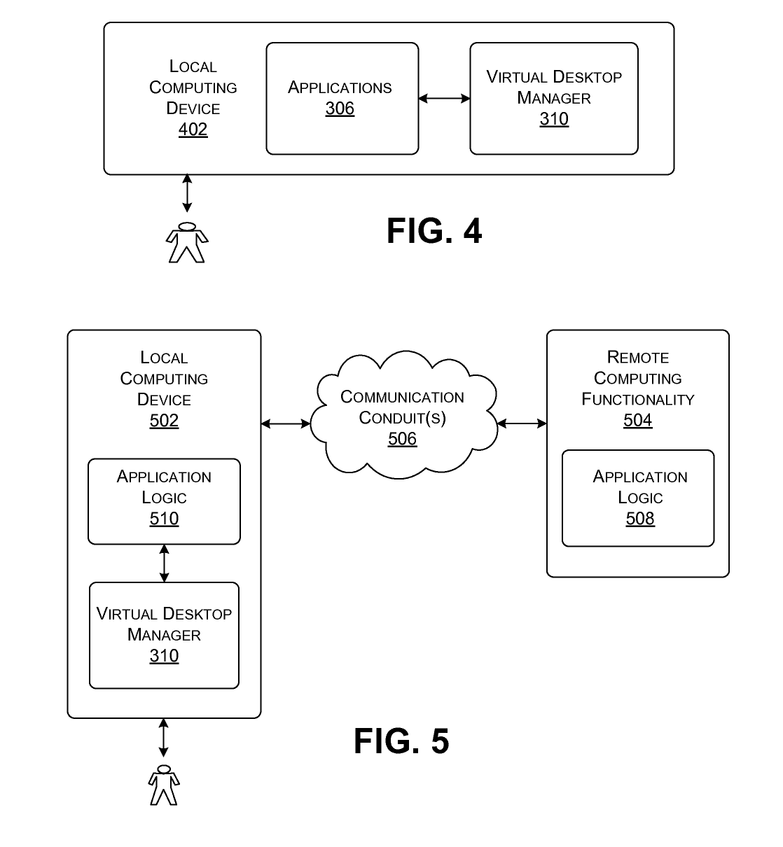

FIG. 4 shows one implementation of a computing device 402 that can implement the computing functionality 302 of FIG. 2. The computing device 402 may correspond to any of a computer workstation, a game console device, a set-top box, a smartphone device, a tablet-type computing device, a media consumption device (e.g., a music-playing device or a book-reader device), and so on. The computing device 402 may locally provide logic associated with one or more applications 306 and the virtual desktop manager 310.

FIG. 5 shows another implementation of computing equipment that can implement the computing functionality 302 of FIG. 2. Here, the computing equipment may include a local computing device 502 (with which the user interacts), which is coupled to remote computing functionality 504 via any communication conduit(s) 506. The local computing device 502 may correspond to any of the devices mentioned above with reference to FIG. 4. The remote computing functionality 504 may correspond to one or more computer servers, one or more data stores, and/or other computing functionality (e.g., routers, loading balancing equipment, etc.). The communication conduit(s) 506 may correspond a wide area network (e.g., the Internet), a local area network, and any combination thereof.

In one case, the remote computing functionality 504 can host one or more applications, generally depicted in FIG. 5 as remote application logic 508. For example, the applications may correspond to web-enabled applications. The user may interact with the web-enabled applications via browser functionality provided by the local computing device 502.

The local computing device 502 is illustrated as including local application logic 510 and the virtual desktop manager 310. The local application logic 510 corresponds to whatever application-related functionality (if any) that the local computing device 502 FIG. 5 uses to interact with the remote application logic 508, implemented by the remote computing functionality 504. For example, in one implementation, the local application logic 510 may correspond to local logic which displays a local version of a window that is generated by the remote application logic 508 hosted by the remote computing functionality 504.

Note that FIG. 5 shows that the virtual desktop manager 310 is implemented by the local computing device 502. But in other implementations, the functionality of the virtual desktop manager 310 can also be distributed between the local computing device 502 and the remote computing functionality 504 in any manner. Further, in other standalone and distributed implementations, the computing equipment may entirely omit a virtual desktop manager, or omit the use of the virtual desktop manager.

### First Illustrative Implementation

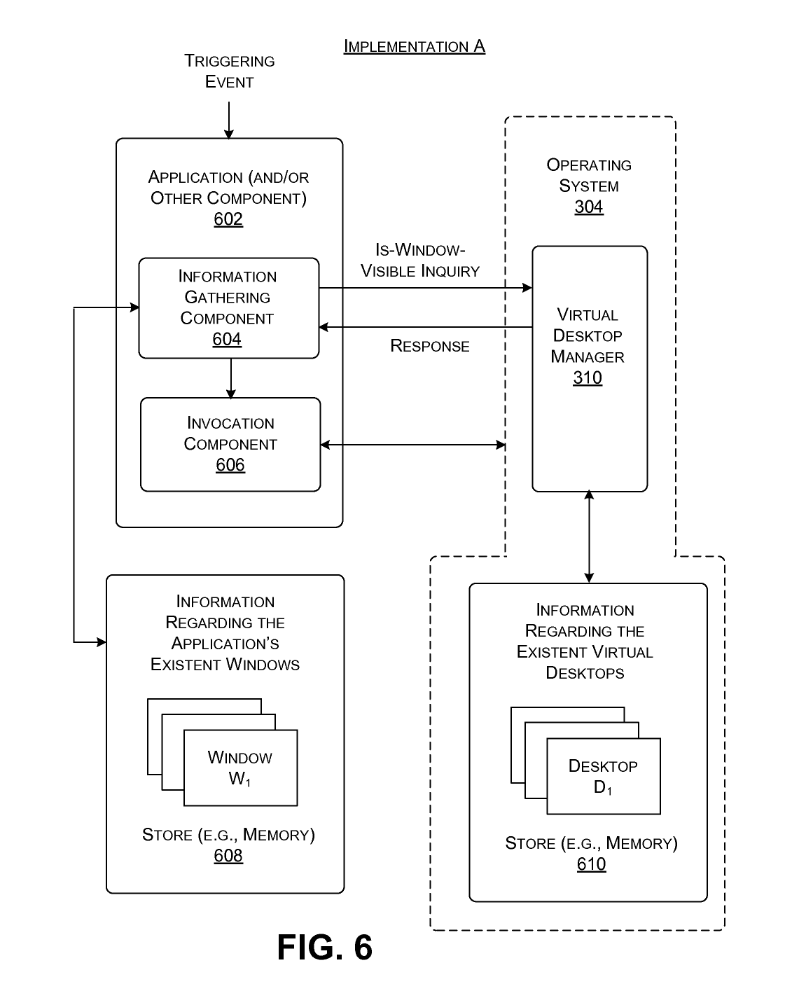

Advancing now to FIG. 6, this figure shows a first implementation of the system 102 of FIG. 1. In this case, assume that the user (or some other entity) makes a request for the presentation of a window associated with an application 602. For example, in one case, the request may instruct a computing device to launch the application 602, upon which it will present an introductory window. The window that is requested is referred to as the “requested window” herein.

In the example of FIG. 6, each application implements an instance of the window-invoking functionality 104 introduced above. Thus, the application 602 implements an information gathering component 604 and an invocation component 606.

The information gathering component 604 collects context information that relates to the circumstance in which the window is being requested. In operation, the information gathering component 604 may first consult a data store 608 to determine all windows associated with the application 602 that exist at the current time across the various virtual desktops. The application 602 may provide this information in an application-specific data store, and/or the operating system 304 may store this information.

The information gathering component 604 may also consult a data store 610 that provides information regarding all of the virtual desktops that exist at the current time, and the windows that are being presented in those virtual desktops. The virtual desktop manager 310 may maintain that information in the data store 610, or some other component of the operating system 304 may maintain this information.

More specifically, for each identified window in the data store 608, the information gathering component 604 can query the virtual desktop manager 310 to determine whether that window is present in the current visual desktop. Upon the conclusion of this procedure, the information gathering component 604 can determine whether the requested window associated with the application 602 is currently being displayed in the current virtual desktop. In one implementation, the information gathering component 604 can implement its interrogation technique using an Application Programming Interface (API). That API accepts a window identifier as an input identifier, and receives a Yes/No response from the virtual desktop manager 310 which indicates whether the identified window is present in the current virtual desktop.

The invocation component 606 may then determine how to present the requested window based on the conclusion reached by the information gathering component 604. For instance, the invocation component 606 can perform the behavior shown in FIG. 2 by: (1) displaying the requested window in the current virtual desktop, providing that the current virtual desktop does not currently present the requested window (and irrespective of whether any other virtual desktop may present the requested window); or (2) activating an already-present version of the requested window in the current virtual desktop, assuming that it exists.

### Second Illustrative Implementation

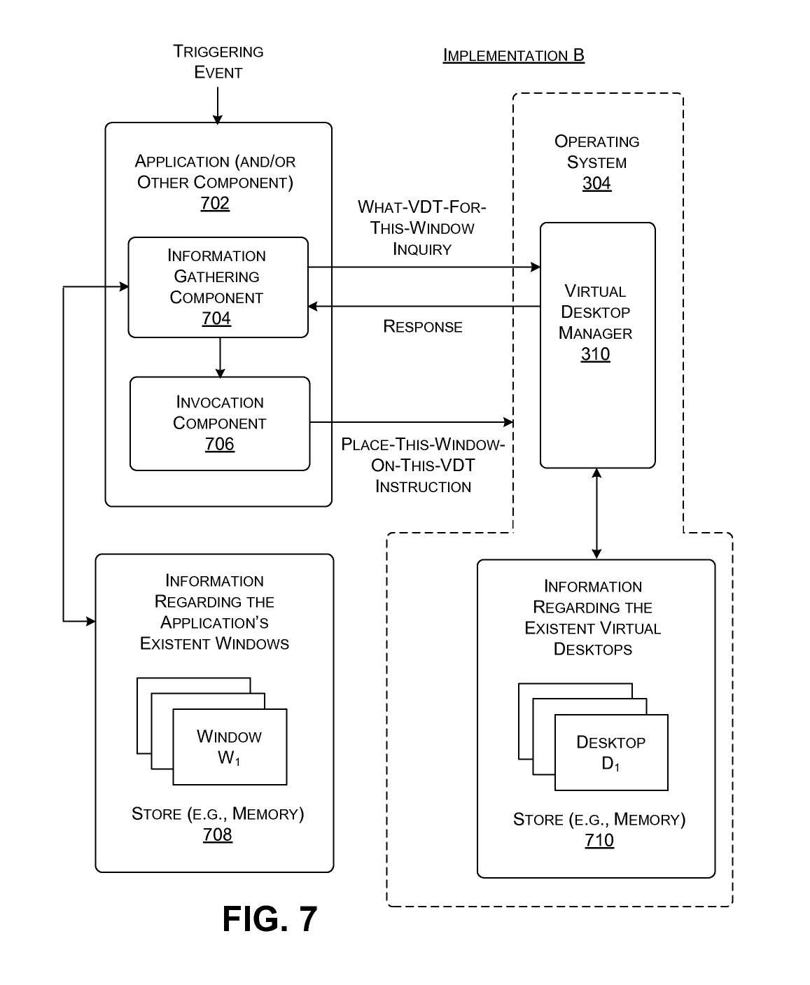

FIG. 7 shows a second implementation of the system of FIG. 1. This figure again shows an application 702 which implements an instance of the window-invoking functionality 104, e.g., by providing an information gathering component 704 and an invocation component 706. The information gathering component 704 retrieves information regarding the application's existent windows (e.g., as maintained in a data store 708). The information gathering component 704 also retrieves information regarding all of the virtual desktops that exist at the current time (e.g., as maintained in a data store 710 by the virtual desktop manager 310).

More specifically, the functionality associated with FIG. 7 may be applied to different scenarios, and is best explained in the context of illustrative scenarios. In one scenario, assume that the application 702 pertains to an online Email service. That type of application 702 may generate a main window through which the user may interact with his or her inbox. The application 702 may also occasionally automatically generate a pop-up window which alerts the user to the occurrence of a soon-to-occur meeting. In another case, the application 702 performs a photo editing application. That type of application 702 may generate a main window which provides a main workspace in which the user may edit an image. The application 702 may also generate supplemental (satellite) windows that present tools and other resources for use in editing the image in the main workspace.

In the example of FIG. 7, at some juncture, the information gathering component 704 determines the placement of its different windows (for application 702) in its various virtual desktops. It can perform this task by interrogating the virtual desktop manager 310 for each existent window, asking the virtual desktop manager to return the identity of the virtual desktop(s) on which this window appears. Based on these inquiries, the information gathering component 704 can determine the virtual desktop that contains the main inbox window (in the case of the above Email service example) or the main workspace window (in the case of the photo editing example).

The information gathering component 704 may perform its interrogation based on any triggering event. For example, in some cases, the information gathering component 704 may periodically perform the interrogation to determine the mapping between the existent windows and the existent virtual desktops. In other cases, the information gathering component 704 can perform the interrogation when it receives a request to display each new window. For example, in the Email service case, the information gathering component 704 can perform its inquiry when it receives a request to display a reminder message. The photo editing application can perform its inquiry when it receives a request to display a satellite palette window, etc.

The invocation component 706 may then determine where to place a window based on the conclusions of the information gathering component 704. For example, assume that the triggering event pertains to the receipt of a reminder message in the above-described Email service example. The information gathering component 704 can determine what virtual desktop displays the main inbox window, if that window exists. As noted above, the information gathering component 704 can make this determination in advance of the receipt of the reminder window, or in an on-demand manner, e.g., upon activation of a request for the reminder window. Then the invocation component 706 can assign the reminder window to the same virtual desktop as the main inbox window. In some cases, the user may not be currently interacting with the virtual desktop in which the main inbox window appears. In that circumstance, the operating system 304 can alert the user to the fact that new information has been received in another virtual desktop in various ways, such as by generating an alert in a taskbar associated with that other virtual desktop.

In one implementation, the information gathering component 704 can implement its interrogation technique using an API. That API accepts a window identifier as an input parameter, and receives a virtual desktop ID as a return parameter. Similarly, the invocation component 706 can implement its setting technique using an API, which also accepts a window identifier as an input parameter.

In a second scenario, assume that the application 702 is implemented as an online remote application having a local logic component and a remote logic component (as in the case of FIG. 5). The remote logic component may generate windows for display at a local computing device. The local logic component may use the virtual desktop manager 310 to maintain one or more virtual desktops for displaying the windows generated by the remote logic component. Further, the local logic component forwards any changes made by the user to the remote logic component.

In the above environment, assume that the virtual desktop manager 310 currently maintains at least two virtual desktops. Further assume that the remote application session provided by the remote logic component suspends or locks for any reason, and then later resumes. Upon resumption of the session, the remote logic component will attempt to reconstitute all of the windows that were being displayed by the local logic component on its various desktops. However, without the intervention of the solution described in FIG. 7, the local logic component may respond to the reactivation of the windows by loading them all in the current virtual desktop.

To avoid the above result, at the time that a session locks, the information gathering component 704 can be used to determine the affiliation between each window and its associated virtual desktop. Then, when the session is later restored and there is a request to reconstitute the windows, the invocation component 706 can use the information collected by the information gathering component 704 to place each reconstituted window in its appropriate virtual desktop (rather than dumping all of the windows in the current virtual desktop).

In a third scenario, assume that the application 702 is a word processing application. In that application, the user may use a first virtual desktop to open a main workspace window, and then create a draft document within a main workspace window. The user may leave that document “open” on the main workspace window and then advance to a second virtual workspace for any reason. Within the second virtual desktop, the user may then again activate the application 702. At that juncture, the second virtual desktop may present a window that shows some type of indication that a document is being created, such as by displaying the name of this document file in a draft folder. Finally, assume that the user wishes to resume editing the document within the second virtual desktop. To do so, the user may click on the file name in the draft folder within the window presented in the second virtual desktop.

In many environments, it may be considered undesirable to maintain two versions of the same in-progress document on two different virtual desktops. To address this issue, the information gathering component 704 can send a query to the virtual desktop manager 310, asking it to identify the virtual desktop that hosts the main workspace window in which the document remains open. The invocation component 706 can then perform a consolidating action based on the information reported by the information gathering component 704. For example, the invocation component 706 can reassign the main workspace window from the first virtual desktop to the second virtual desktop, allowing the user to resume editing of the document within the second virtual desktop. At that juncture, if the user returns to the first virtual desktop he or she will find that the main workspace window is no longer present in the first virtual desktop. Alternatively, the invocation component 706 can launch the user back into the first virtual desktop, rather than open a new window in the second virtual desktop.

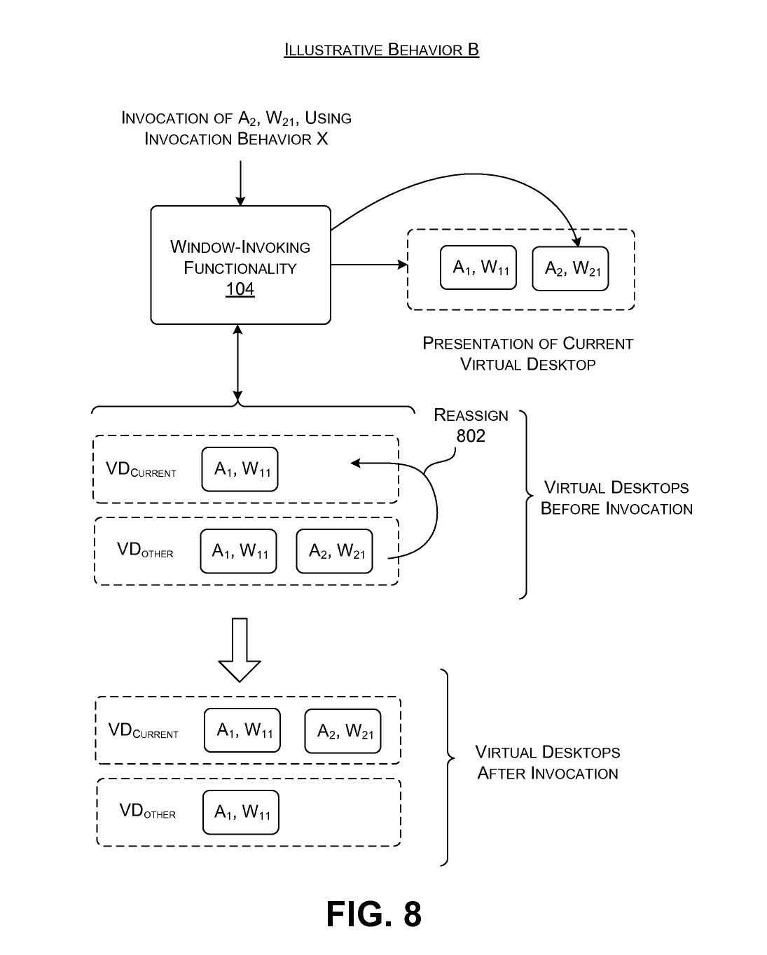

FIG. 8 pictorially illustrates the operations entailed by the above-described third scenario. Assume that the application 702 corresponds to application A₂. The first virtual desktop corresponds to the desktop VD_{Other} in which the user creates the document, via a main workspace window (W₂₁, A₂). Next the user advances to a second virtual desktop (VD_{Current}), where he or she opens the same application A₂ and clicks on the in-progress document in the draft folder. At this juncture, the invocation component 706 “moves” the window (W₂₁, A₂) from VD_{Other} to VD_{Current}, as indicated by reassignment path 802. As a point of clarification, note that the scenario depicted in FIG. 8 involves actually removing a window from one virtual desktop and placing it in another virtual desktop. But in the first two scenarios set forth above, the behavior associated with the second implementation (of FIG. 7) involves the assignment of windows that are newly invoked, rather than the reassignment of already invoked windows.

### Third Illustrative Implementation

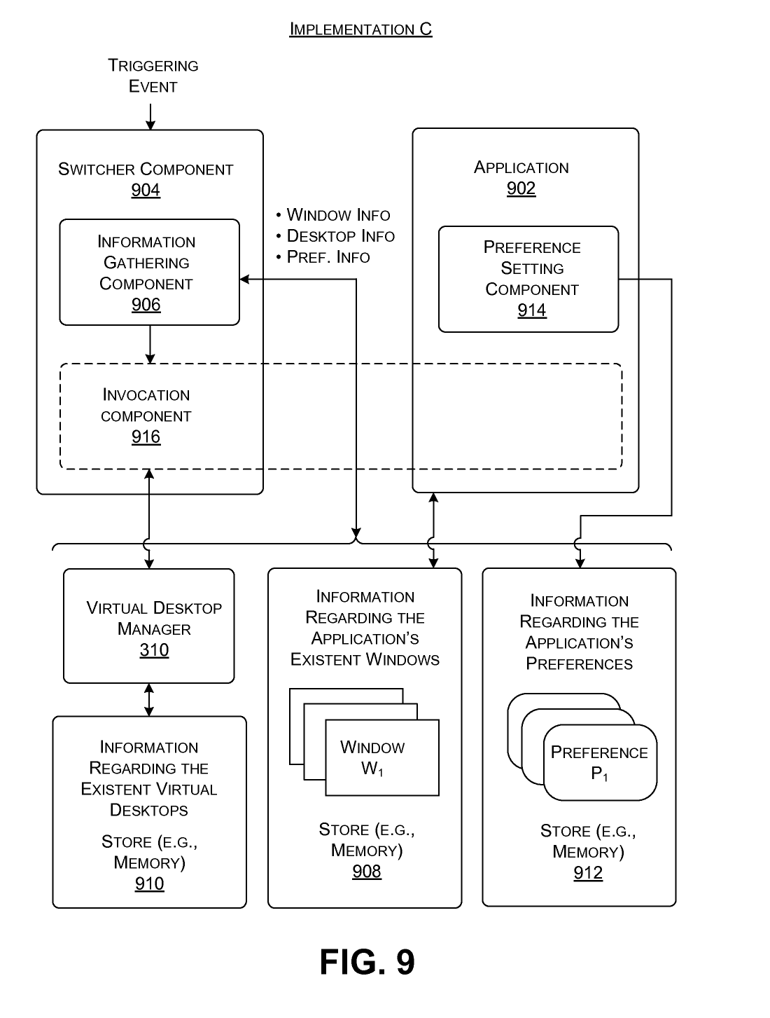

FIG. 9 shows a third implementation of the window-invoking functionality 104. In this case, all components of the figure are implemented by the operating system 304, except an application 902. More specifically, a switcher component 904 (corresponding to part of the operating system 304) serves as the primary agent for gathering information and invoking a window instance (as opposed to the application 902, as was the case in FIGS. 6 and 7).

Upon a triggering event, an information gathering component 906 (of the switcher component 904) retrieves context information from various sources. The collected information may include information regarding the application's existent windows, e.g., as maintained in some data store 908 accessible to the operating system 304. The collected information may also include information regarding the existent virtual desktops maintained by the virtual desktop manager 310, as provided in a data store 910. The collected information may also include information regarding application preferences, as maintained in a data store 912. That information is referred to preference information herein. Although not shown, the context information may include additional instances of context information, such as invocation characteristic information that describes the manner in which the application 902 has been invoked.

The application 902 may set the preference information in the data store 912 at any juncture, such as at install time (which is when the application 902 was installed on the computing device), or at runtime (which is when the application 902 is executed on the computing device), and/or at some other time. The application 902 may use a preference setting component 914 to set the preferences, which may be implemented as an API.

The preference information provides one or more rules which describe how the window-invoking functionality 104 should present a requested window based on one or more contextual factors. For example, as noted above, one rule may specify certain presentation behavior that depends on a manner in which the user has launched the application 902.

An invocation component 916 next determines how to present the requested window based on all of the collected context information. The invocation component 916 then invokes the requested window in a chosen virtual desktop, in a prescribed manner. The invocation component 916 can be physically implemented in different ways, as pictorially represented in FIG. 9 by the general dashed-line depiction of the invocation component 916. In a first implementation, the switcher component 904 (which is a component of the operating system 304) implements at least part of the operations associated with the invocation component 916. In a second implementation, the application 902 implements at least part of the operations associated with the invocation component 916, e.g., based on instructions received from the switcher component 904. Still other implementations are possible.

Note that the architecture of FIG. 9 exhibits different behavior compared to, for example, the architecture of FIG. 6. In the case of FIG. 6, the application logic associated with the application 602 is the agent which interrogates the virtual desktop manager 310 to collect context information. To perform this operation, it is therefore necessary to wake the application 602 up and wait for it to perform its data collection task. These operations may result in a slight delay in the loading of the application 602, after the end user issues a command to invoke the application 602.

In contrast, in the implementation of FIG. 9, the switcher component 904 (which, to repeat, is a component of the operating system 304) performs the collection task, and then decides how to present the requested window, without the involvement of the application 902. The window-invoking functionality 104 can leverage this characteristic by more quickly presenting at least introductory information regarding the application that is to be invoked, compared to the example of FIG. 6. As a final outcome, the user may experience the implementation of FIG. 9 as offering a quicker application launch time, compared to the example of FIG. 6.

As a final point regarding the implementation of FIG. 9, note that the preference information may control any aspect of a requested window's presentation, in addition to (or instead of) selecting the virtual desktop to be used to display the requested window. For example, as noted above, the preference information may control the location of the requested window in the virtual desktop, the size of the requested window (and/or any other visual attribute of the requested window), the behavior of the requested window, and so on. And to repeat, any of these preference considerations can be applied to the presentation of windows on a single virtual desktop (e.g., for the case in which there is only one existent virtual desktop), or on an ordinary non-virtual desktop.

For instance, again consider the above-cited case in which the application 902 performs a calculation function. The preference information may indicate that: (a) if the user invokes the calculator application while also using a second application (such as a tax preparation application) on the same desktop, that desktop should display the requested window in a small-size format; (b) but if the user invokes the calculator application without any other window on the current desktop, then the current virtual desktop should display the requested window in a larger-size format. This preference is based on the assumption that, if the user is using a second application (e.g., the tax preparation application), the user may not want the calculator window to obscure a large portion of the visible virtual desktop.

B. Illustrative Process

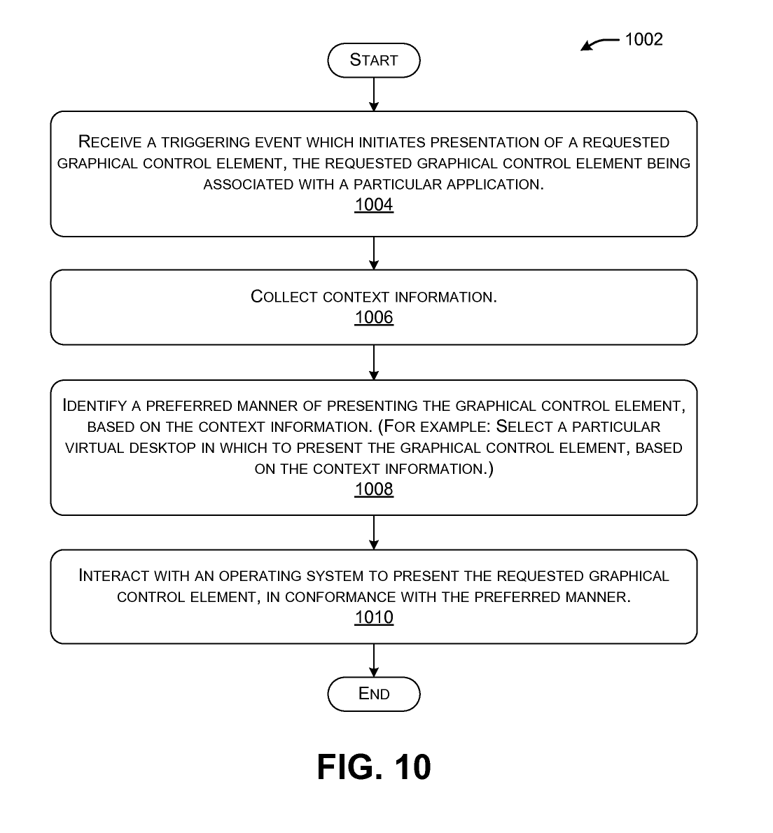

FIG. 10 shows a process 1002, performed by one or more computing devices (402, 502), that explains the operation of the window-invoking functionality 104 of Section A in flowchart form. Since the principles underlying the operation of the migration functionality have already been described in Section A, certain operations will be addressed in summary fashion in this section.

In block 1004, the window-invoking functionality 104 receives a triggering event which initiates presentation of a requested graphical control element (e.g., a window). The requested graphical control element is associated with a particular application. In block 1006, the window-invoking functionality 104 collects context information. In block 1008, the window-invoking functionality 104 identifies a preferred identified manner of presenting the graphical control element, based on the context information. In block 1010, the window-invoking functionality 104 interacts with an operating system 304 of the computing device(s) (402, 502) to present the requested graphical control element in conformance with the preferred identified manner.

For instance, in block 1008, the window-invoking functionality 104 can select a particular virtual desktop in which to present the graphical control element, based on the context information. In block 1010, the window-invoking functionality 104 can interact with the operating system 304 to present the requested graphical control element on the particular virtual desktop. In other words, the preferred identified manner in this case specifies a virtual desktop on which the requested window is to be presented. But alternatively, or in addition, the preferred identified manner may specify a display characteristic of the requested window (e.g., its size, position, behavior, presentation device, etc.), even in those cases in which the user is only interacting with a single desktop.

In one implementation, the context information includes one or more of: information regarding existent graphical control elements associated with the particular application; information regarding existent virtual desktops provided by the virtual desktop manager; invocation characteristic information, corresponding to a manner by which the triggering event has been produced; and/or application preference information specified by the particular application, the application preference information identifying a preferred manner of invoking the requested graphical control element for the particular application.

In the process of FIG. 10, the information gathering component 108 and the invocation component 110 cooperate, over a span of time, to conserve computing resources (e.g., power) of the computing device(s) (402, 502) by eliminating plural incidents in which a user finds it appropriate to navigate to a desired virtual desktop after being presented with an undesirable virtual desktop. As explained above, launching the user into an undesirable virtual desktop consumes power, because doing so entails waking up the applications hosted by the virtual desktop.

C. Representative Computing Functionality

FIG. 11 shows computing functionality 1102 that can be used to implement any aspect of the system 102 set forth in the above-described figures, such as the window-invoking functionality 104. More specifically, for instance, the type of computing functionality 1102 shown in FIG. 11 can be used to implement any of the local computing devices (402, 502) of FIGS. 3 and 4, the remote computing functionality 504 of FIG. 5, and so on. In all cases, the computing functionality 1102 represents one or more physical and tangible processing mechanisms.

The computing functionality 1102 can include one or more processing devices 1104, such as one or more central processing units (CPUs), and/or one or more graphical processing units (GPUs), and so on.

The computing functionality 1102 can also include any storage resources 1106 for storing any kind of information, such as code, settings, data, etc. Without limitation, for instance, the storage resources 1106 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1102. The computing functionality 1102 may perform any of the functions described above when the processing devices 1104 carry out instructions stored in any storage resource or combination of storage resources. The computing functionality 1102 also includes one or more drive mechanisms 1108 for interacting with any storage resource, such as a hard disk drive mechanism, an optical disk drive mechanism, and so on.

As to terminology, any of the storage resources 1106, or any combination of the storage resources 1106, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1102 also includes an input/output module 1110 for receiving various inputs (via input devices 1112), and for providing various outputs (via output devices 1114). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1116 and an associated graphical user interface (GUI) 1118. Other output devices include a printer, a speaker or speakers, a model-generating mechanism, a tactile output mechanism, an archival mechanism (for storing output information), and so on. The computing functionality 1102 can also include one or more network interfaces 1120 for exchanging data with other devices via one or more communication conduits 1122. One or more communication buses 1124 communicatively couple the above-described components together.

The communication conduit(s) 1122 can be implemented in any manner, e.g., by a local area network, a wide area network (e.g., the Internet), point-to-point connections, etc., or any combination thereof. The communication conduit(s) 1122 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1102 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In conclusion, the following summary provides a non-exhaustive list of illustrative aspects of the technology set forth herein.

According to a first aspect, one or more computing devices are described herein for invoking a graphical control element. The computing device(s) include logic configured to receive a triggering event which initiates presentation of a requested graphical control element, the requested graphical control element being associated with a particular application, and being requested in a context of interaction, by a user, with a current virtual desktop. The computing device(s) also include an information gathering component configured to collect context information that includes at least: (1) information regarding existent graphical control elements associated with the particular application, as stored by the computing device(s); and (2) information regarding existent virtual desktops provided by a virtual desktop manager, as stored by the computing device(s). The computing device(s) also includes an invocation component configured to: select a particular virtual desktop in which to present the graphical control element, based on the context information; and interact with an operating system of the computing device(s) to present the requested graphical control element on the particular virtual desktop. Overall, the information gathering component and the invocation component cooperate, over a span of time, to conserve computing resources of the computing device(s) by eliminating plural incidents in which the user finds it appropriate to navigate to a desired virtual desktop after being presented with an undesirable virtual desktop.

According to a second aspect, the information gathering component and the invocation component are implemented, at least in part, by the particular application.

According a third aspect, the information gathering component and the invocation component are implemented, at least in part, by the operating system of the computing device(s).

According to a fourth aspect, the context information indicates that when the requested graphical control element corresponds to an already-present graphical control element in the current virtual desktop, the invocation component is configured to interact with the operating system to activate the already-present graphical control element in the current virtual desktop. But when the context information indicates that the requested graphical control element is not already present in the current virtual desktop, the invocation component is configured to newly present the requested graphical control element in the current virtual desktop, irrespective of whether the requested graphical control element is already present in another virtual desktop.

According to a fifth aspect, the context information also includes preference information specified by the particular application. The preference information identifies a preferred manner of invoking the requested graphical control element for the particular application. The invocation component is configured to select the particular virtual desktop, at least in part, based on the preference information.

According to a sixth aspect, the particular application provides the above-mentioned preference information to the operating system of the computing device(s).

According to a seventh aspect, the particular application provides the preference information to the operating system when the particular application is installed on the computing device(s).

According to an eighth aspect, the context information also includes invocation characteristic information, which identifies a manner by which the triggering event has been produced. Here, the invocation component is configured to select the particular virtual desktop, at least in part, based on invocation characteristic information.

According to a ninth aspect, the above-mentioned invocation characteristic information indicates that the triggering event has been produced in response to a user activating a particular file item.

According to a tenth aspect, the invocation characteristic information indicates that the triggering event has been produced in response to a user using a particular protocol.

According to an eleventh aspect, the invocation characteristic information indicates that the triggering event has been produced in response to an identified user behavior.

According to a twelfth aspect, the information gathering component is configured to gather the context information by interrogating the virtual desktop manager to determine whether the requested graphical control element is present in the current virtual desktop.

According to a thirteenth aspect, the interrogation component is configured to gather the context information by querying information maintained by the operating system, without waking the application up, thereby further conserving computing resources of the computing device(s).

According to a fourteenth aspect, the information gathering component is configured to gather the context information by interrogating the virtual desktop manager with respect to a specified already-presented graphical control element, to determine an identity of a virtual desktop that is being used to present the already-presented graphical control element.

According to a fifteenth aspect, the invocation component is configured to instruct the virtual desktop manager to present the requested graphical control element on a same virtual desktop as the already-presented graphical control element, based on information provided by the information gathering component which provides the identity of that virtual desktop which hosts the already-presented graphical control element.

According to a sixteenth aspect, the invocation component is also configured to select a display characteristic based on the context information. The display characteristic identifies a visual and/or behavioral characteristic of the requested graphical control element, when presented on the particular virtual desktop, and/or describes a characteristic of one or more presentation devices on which the graphical control element is to be presented. The invocation component is also configured to present the requested graphical control element on the particular virtual desktop in conformance with the display characteristic.

According a seventeenth aspect, a method is described herein, implemented by at least one computing device, for presenting a graphical control element on a graphical user interface of a presentation device. The method includes: receiving a triggering event which initiates presentation of a requested graphical control element, the requested graphical control element being associated with a particular application; collecting context information; identifying a preferred identified manner of presenting the graphical control element, based on the context information, without waking the particular application up if the application is presently asleep; and interacting with an operating system of the computing device(s) to present the requested graphical control element in conformance with the preferred identified manner. The context information includes: information regarding existent graphical control elements associated with the particular application, as stored by the computing device(s); information regarding existent virtual desktops provided by a virtual desktop manager, as stored by the computing device(s); and preference information specified by the particular application, as stored by the computing device(s), the preference information identifying a preferred manner of invoking the requested graphical control element for the particular application.

According to an eighteenth aspect, the preferred identified manner identifies a particular virtual desktop on which to present the requested graphical control element.

According to a nineteenth aspect, the preferred identified manner identifies a display characteristic, the display characteristic identifying a visual and/or behavioral characteristic of the requested graphical control element, when presented on a desktop, and/or describing a characteristic of one or more presentation devices on which the graphical control element is to be presented.

According to a twentieth aspect, a computer readable storage medium for storing computer readable instructions is described herein, the computer readable instructions implementing window-invoking functionality when executed by one or more processing devices. The computer readable instructions include logic configured to receive a triggering event which initiates presentation of a requested graphical control element, the requested graphical control element being associated with a particular application, and being requested in a context of interaction, by a user, with a current virtual desktop; logic configured to collect context information; logic configured to select a particular virtual desktop in which to present the graphical control element, based on the context information; and logic configured to present the requested graphical control element on the particular virtual desktop. The context information includes at least one or more of: information regarding existent graphical control elements associated with the particular application; information regarding existent virtual desktops provided by a virtual desktop manager; invocation characteristic information, corresponding to a manner by which the triggering event has been produced; and/or preference information specified by the particular application, the preference information identifying a preferred manner of invoking the requested graphical control element for the particular application.

A twenty-first aspect corresponds to any combination (e.g., any permutation or subset) of the above-referenced first through twentieth aspects.

A twenty-second aspect corresponds to any method counterpart, device counterpart, system counterpart, means counterpart, computer readable storage medium counterpart, data structure counterpart, article of manufacture counterpart, graphical user interface presentation counterpart, etc. associated with the first through twenty-first aspects.

In closing, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computing devices for invoking a graphical control element, comprising:
logic configured to receive a triggering event which initiates presentation of a requested graphical control element, the requested graphical control element being associated with a particular application, and being requested in a context of interaction, by a user, with a current virtual desktop;
an information gathering component configured to collect context information that includes at least:
information regarding existent graphical control elements associated with the particular application, as stored by said one or more computing devices; and
information regarding existent virtual desktops provided by a virtual desktop manager, as stored by said one or more computing devices; and
an invocation component configured to:
select a particular virtual desktop in which to present the graphical control element, based on the context information; and
interact with an operating system of said one or more computing devices to present the requested graphical control element on the particular virtual desktop,
the information gathering component and the invocation component cooperating, over a span of time, to conserve computing resources of said one or more computing devices by eliminating plural incidents in which the user finds it appropriate to navigate to a desired virtual desktop after being presented with an undesirable virtual desktop.

2. The one or more computing devices of claim 1, wherein the information gathering component and the invocation component are implemented, at least in part, by the particular application.

3. The one or more computing devices of claim 1, wherein the information gathering component and the invocation component are implemented, at least in part, by the operating system of said one or more computing devices.

4. The one or more computing devices of claim 1,
when the context information indicates that the requested graphical control element corresponds to an already-present graphical control element in the current virtual desktop, the invocation component is configured to interact with the operating system to activate the already-present graphical control element in the current virtual desktop, and
when the context information indicates that the requested graphical control element is not already present in the current virtual desktop, the invocation component is configured to newly present the requested graphical control element in the current virtual desktop, irrespective of whether the requested graphical control element is already present in another virtual desktop.

5. The one or more computing devices of claim 1,
wherein the context information also includes preference information specified by the particular application, the preference information identifying a preferred manner of invoking the requested graphical control element for the particular application, and
wherein the invocation component is configured to select the particular virtual desktop, at least in part, based on the preference information.

6. The one or more computing devices of claim 5, wherein the particular application provides the preference information to the operating system of said one or more computing devices.

7. The one or more computing devices of claim 6, wherein the particular application provides the preference information to the operating system when the particular application is installed on said one or more computing devices.

8. The one or more computing devices of claim 1,
wherein the context information also includes invocation characteristic information, which identifies a manner by which the triggering event has been produced, and
wherein the invocation component is configured to select the particular virtual desktop, at least in part, based on invocation characteristic information.

9. The one or more computing devices of claim 8, wherein the invocation characteristic information indicates that the triggering event has been produced in response to a user activating a particular file item.

10. The one or more computing devices of claim 8, wherein the invocation characteristic information indicates that the triggering event has been produced in response to a user using a particular protocol.

11. The one or more computing devices of claim 8, wherein the invocation characteristic information indicates that the triggering event has been produced in response to an identified user behavior.

12. The one or more computing devices of claim 1, wherein the information gathering component is configured to gather the context information by interrogating the virtual desktop manager to determine whether the requested graphical control element is present in the current virtual desktop.

13. The one or more computing devices of claim 1, wherein the interrogation component is configured to gather the context information by querying information maintained by the operating system, without waking the application up, thereby further conserving computing resources of said one or more computing devices.

14. The one or more computing devices of claim 1, wherein the information gathering component is configured to gather the context information by interrogating the virtual desktop manager with respect to a specified already-presented graphical control element, to determine an identity of a virtual desktop that is being used to present the already-presented graphical control element.

15. The one or more computing devices of claim 14, wherein the invocation component is configured to instruct the virtual desktop manager to present the requested graphical control element on a same virtual desktop as the already-presented graphical control element, based on information provided by the information gathering component which provides the identity of that virtual desktop which hosts the already-presented graphical control element.

16. The one or more computing devices of claim 1,
wherein the invocation component is also configured to select a display characteristic based on the context information, the display characteristic identifying a visual and/or behavioral characteristic of the requested graphical control element, when presented on the particular virtual desktop, and/or describing a characteristic of one or more presentation devices on which the graphical control element is to be presented, and
wherein the invocation component is also configured to present the requested graphical control element on the particular virtual desktop in conformance with the display characteristic.

17. A method, implemented by at least one computing device, for presenting a graphical control element on a graphical user interface of a presentation device, comprising:
receiving a triggering event which initiates presentation of a requested graphical control element, the requested graphical control element being associated with a particular application;
collecting context information that includes at least:
information regarding existent graphical control elements associated with the particular application, as stored by said at least one computing device;
information regarding existent virtual desktops provided by a virtual desktop manager, as stored by said at least one computing device; and
preference information specified by the particular application, as stored by said at least one computing device, the preference information identifying a preferred manner of invoking the requested graphical control element for the particular application;
identifying a preferred identified manner of presenting the graphical control element, based on the context information, without waking the particular application up if the application is presently asleep; and
interacting with an operating system of said at least one computing device to present the requested graphical control element in conformance with the preferred identified manner.

18. The method of claim 17, wherein the preferred identified manner identifies a particular virtual desktop on which to present the requested graphical control element.

19. The method of claim 17, wherein the preferred identified manner identifies a display characteristic, the display characteristic identifying a visual and/or behavioral characteristic of the requested graphical control element, when presented on a desktop, and/or describing a characteristic of one or more presentation devices on which the graphical control element is to be presented.

20. A computer readable storage medium for storing computer readable instructions, the computer readable instructions implementing window-invoking functionality when executed by one or more processing devices, the computer readable instructions comprising:
logic configured to receive a triggering event which initiates presentation of a requested graphical control element, the requested graphical control element being associated with a particular application, and being requested in a context of interaction, by a user, with a current virtual desktop;
logic configured to collect context information that includes at least one or more of:
information regarding existent graphical control elements associated with the particular application;
information regarding existent virtual desktops provided by a virtual desktop manager;
invocation characteristic information, corresponding to a manner by which the triggering event has been produced; and/or
preference information specified by the particular application, the preference information identifying a preferred manner of invoking the requested graphical control element for the particular application;
logic configured to select a particular virtual desktop in which to present the graphical control element, based on the context information; and
logic configured to present the requested graphical control element on the particular virtual desktop.
